(19) United States
(12) Patent Application Publication
(10) Pub. No.: US 2016/0263740 A1
(43) Pub. Date: Sep. 15, 2016

(54) CABLIE TIE ORGANIZER

(71) Applicant: Randy SACKFIELD, London (CA)

(72) Inventor: Randy Sackfield, London (CA)

(21) Appl. No.: 15/031,919

(22) PCT Filed: Oct. 23, 2014
(86) PCT No.: PCT/CA2014/051025

§ 371 Date: Apr. 25, 2016

Related U.S. Application Data
(60) Provisional application No. 61/894,682, filed on Oct. 23, 2013.

(51) Int. Cl. B25H 3/00; B65D 85/08

(52) U.S. Cl. CPC B25H 3/00; B65D 85/08

(57) ABSTRACT

A cable tie organizer, which may be free standing or secured to a support, having two or more compartments, each compartment configured to accommodate a different length of cable ties. A foamed elongated member holder having two ends and a bore extending between the two ends, the bore being sized for frictionally holding elongated members therein. The elongated members may include cable tie holders.

### FIELD OF THE INVENTION

The present invention relates to cable tie organizers.

### BACKGROUND OF THE INVENTION

Cable ties, which may also be referred to as tie strap, zip tie or tie-wrap, are a type of fastener, designed for bunching electric cables or wires and to organize cables and wires, or for fastening other fastening type jobs. Cable ties are used by a good majority of the population including home owners and professionals. In its most popular form, a cable tie consists of a sturdy nylon tape with an integrated gear rack, and on one end a ratchet within a small open case. Once the pointed tip of the cable tie has been pulled through the case and past the ratchet, it is prevented from being pulled back; the resulting loop may only be pulled tighter. This allows several cables to be bound together into a cable tree. A cable tie includes a tie or tape portion and a head portion. The tie portion is inserted through a slot of the head portion. The slot allows for insertion of the tie portion and prevents de-insertion of the tie portion.

Convenience and organization of cable ties always seems to be a problem. Cable ties may be sold by the unit, or in bags of 25, 50 100 or more ties per bag. The first problem is to open a typical bag of cable ties: one has to tear it with fingers or teeth, use scissors or a knife, thus starting the process of disorganization of cable ties. The second problem is that the cable ties slide out of the bags when not handled properly. A third problem is that when trying to retrieve one cable tie, groups of 2 or more cable ties come out. A fourth problem is that due to the size and shape of the bags and/or lose cable ties, cable ties always end up scattered through out a place of work. A fifth problem is that once opened, cable tie bags are difficult to close or there is no way to close the bag. All these problems combined with the fact that most users keep their cable ties on a shelf, in a tool box, drawer, workbag, storage container and so forth, create a frustrating situation, especially in situations when working on a project in which only one hand is free to find the cable ties.

Therefore, one object of the present invention is to provide a cable tie organizer that overcome the disadvantages of the prior art.

Further and other objects of the invention will be realized from the following Summary of the Invention, the Discussion of the Invention and the embodiments thereof.

### SUMMARY OF THE INVENTION

The present invention provides for a cable tie organizer.

In one embodiment, the present invention provides for a cable tie organizer having two or more compartments, each compartment configured to accommodate a different length of cable ties.

In one embodiment of the present invention, the cable tie organizer is a portable enclosure, and the two or more compartments are configured to accommodate the cable ties horizontally.

In one embodiment of the present invention the cable tie organizer is a table top cable tie organizer, and the two or more compartments are configured to accommodate the cable ties in a substantially vertical disposition, each compartment including an open top end, a bottom closed end, and substantially vertical side walls extending between the top end and the bottom end, the bottom closed ends of the compartments being aligned so as to provide a generally flat support base, the cable tie organizer including at least two compartments having different heights.

In another embodiment of the present invention, the cable tie organizer is a free standing cable tie organizer.

In another embodiment of the present invention, the cable tie organizer further includes a cable tie holder within one or more compartments.

In another embodiment of the present invention, the cable tie holder includes two ends and a bore extending between the two ends, the bore being sized for frictionally holding one or more elongated members therein.

In another embodiment of the present invention, the cable tie holder includes a slit that extends substantially longitudinally between the two ends and the slit extends from a surface of the cable tie holder to the bore.

In another embodiment of the present invention, the cable tie holder is made of a foamed material.

In another embodiment of the present invention, each of the two or more compartments includes an indicium, each indicium being associated with the length of cable tie that the corresponding compartment accommodates.

In another embodiment of the present invention, each one of the compartments includes a lid. In one aspect of this embodiment the lid is hinged to the corresponding compartment.

In one embodiment, the present invention provides for a kit. In one embodiment, the kit includes a cable tie organizer of any one of the previous embodiments and cable ties.

In another embodiment, the present invention provides for an elongated member holder, the elongated member holder having two ends and a bore extending between the two ends, the bore being sized for frictionally holding one or more elongated members therein.

In one embodiment of the present invention, the elongated member holder includes a slit that extends substantially longitudinally between the two ends and the slit extends from a surface of the foamed elongated member holder to the bore.

In another embodiment of the present invention, the elongated member holder is foamed and the elongated member is a cable tie.

In another embodiment, the present invention provides a cable tie organizer as substantially described herein with reference to and as illustrated by FIG. 1.

In another embodiment, the present invention provides a cable tie organizer as substantially described herein with reference to and as illustrated by FIG. 2.

In another embodiment, the present invention provides a cable tie holder as substantially described herein with reference to and as illustrated by the drawings.

In another embodiment, the present invention provides a cable kit as substantially described herein with reference to and as illustrated by the drawings.

### BRIEF DESCRIPTION OF THE DRAWINGS

The following figures illustrate various aspects and preferred and alternative embodiments of the invention.

FIG. 1. is a perspective top view of a cable tie organizer in accordance to one embodiment of the present invention.

FIG. 2. is a perspective top view of a portable cable tie organizer in accordance to one embodiment of the present invention.

### DESCRIPTION OF THE INVENTION

### Definitions

Unless defined otherwise, all technical and scientific terms used herein have the same meaning as commonly understood by one of ordinary skill in the art to which this invention belongs. Also, unless indicated otherwise, except within the claims, the use of “or” includes “and” and vice versa. Non-limiting terms are not to be construed as limiting unless expressly stated or the context clearly indicates otherwise (for example “including”, “having” and “comprising” typically indicate “including without limitation”). Singular forms including in the claims such as “a”, “an” and “the” include the plural reference unless expressly stated otherwise. In order to aid in the understanding and preparation of the within invention, the following illustrative, non-limiting, examples are provided.

The Cable Tie Organizer

The present invention, in one embodiment, relates to a cable tie organizer. In one embodiment, the cable tie organizer may include a number of different compartments, such as 2, 3, 4, 5, 6, 7, 8, 9, 10 compartments and so forth. Each compartment may be configured to accommodate cable ties of a different length.

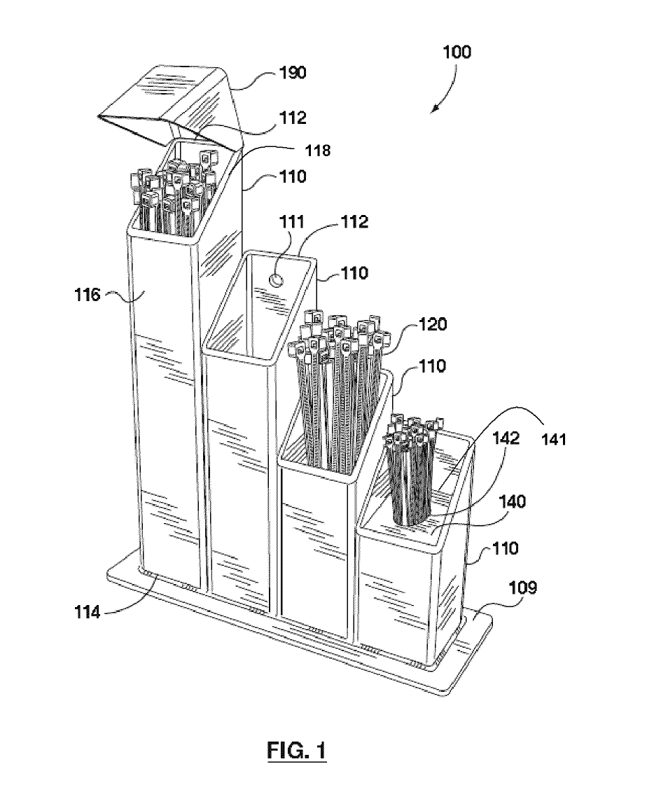

With reference to FIG. 1, in one embodiment, the cable tie organizer may be a free standing, table top cable tie organizer 100. The free standing, table top cable tie organizer 100 may include compartments 110 disposed substantially vertically. FIG. 1 illustrates 4 compartments 110, however, less than 4 compartments (i.e. 2 or 3) or more than 4 compartments are possible. The cable tie organizer may include two or more compartments. The compartments 110 may be configured to accommodate the cable ties 120 in a substantially vertical disposition. Each compartment 110 may include an open top end 112, a closed bottom end 114, and substantially vertical side walls 116 extending between the top end 112 and the closed bottom end 114. The side walls 116 and the bottom end 114 defining a hollowed compartment therein between. The bottom ends 114 of the compartments 110 may be aligned so as to provide a generally flat surface or support base 109 that may serve to rest the cable tie organizer 100 on top of a another generally flat surface, such as on top of a table, desk and so forth. Support base 109 may extend beyond the bottom end of the compartments so as to provide further support to the cable tie organizer 100. The substantially vertical side walls 116 of the compartments 110 may have different lengths so that the cable tie organizer 100 includes compartments 110 having a variety of varying vertical heights. Each compartment may be designed for a cable tie having a specific length. As provided in the background section, cable ties may be provided in a range of lengths, for example form 4 to 60 inches long (about 10.16 to 152.4 cm). Cable ties of a specific length may also be custom-made. As such, the cable tie organizer 100 may include compartments 110 having heights from 2 inches (about 5.08 cm) tall to 58 inches (about 147.32 cm) tall, and heights anywhere in between. Less than 2 inches and more than 60 inches (about 152.4 cm) may also be possible. Ideally, the height of a compartment may be less than the length of the cable tie it is designed to hold. In this manner, the cable ties in a compartment may be easier to see. For example, about 2-3 inches (about 5.08 to 7.62 cm) tall compartments may be used to keep 4 inches (about 10.16 cm) tall cable ties, about 5.5 inches (about 13.97 cm) tall compartment may be used to keep 7.5 inches (about 19.05 cm) cable ties, about 9 inches (about 22.86 cm) tall compartments may be used to keep 11 inches (2.54 cm) cable ties, about 44 inches (about 111.76) tall compartments may be used to keep cable ties longer than 44 inches, for example 45-48 inches (about 114.3 to 121.92 cm) cable ties, and so forth. A cable tie organizer may include compartments for accommodating cable ties of 4″, 7.5″ and 11″. In this case, the compartments may be about 2″, 5.5″ and 9″ tall respectively. In one embodiment, the open top end 112 may include a cut-out, such as diagonal cut-out 118. The diagonal cut-outs 118 may serve to better see the cable ties in a compartment and may facilitate hand picking the cable ties from the compartment.

The compartments may take any shape, such as rectangular, circular, triangular and so forth. In one embodiment, the cable tie organizer may include compartments of different shapes. For example, in one embodiment, a cable tie organizer may include 3 compartments, one being circular, another being triangular and another one being rectangular.

One or more compartments of the cable tie organizer 100 may include insert means 140. Insert means 140 may be made of a deformable material, such as foam inserts. Inserts 140 may, in one embodiment, take the shape of the compartment in which it sits, and be sized to be frictionally received by the compartment. Each insert 140 may include two ends 141 (only the top end is shown) and a bore 142 that extends between the two ends. The bore 142 may serve for frictionally receiving the cable ties 120. The insert means 140 may be removable or it may be fixed to the inside of the compartment. Cable ties may be loaded into the inserts 140 by inserting the tape portion of the cable ties into the bore 142 of the insert means 140 without having to remove the insert 140 from its compartment. Alternatively, the insert means 140 may be removed from a compartment, the bore 142 may be filled with cable ties, and the insert means 140 loaded with the cable ties may then be inserted into the compartment. Once loaded, the head portion of the cable ties may stick outside of the insert 140, while the tape portion of the cable tie is within the bore 142 of the insert 140. The insert 140, which may also be referred to as cable tie holder, may advantageously keep the cable ties within a compartment organized, allows easier retrieval of one cable tie at a time, and allows for the cable ties to remain in the compartment in case the cable tie organizer is dropped or turned over.

Each compartment may include indicia, signs or markings to facilitate the organizing of the cable ties. For example, each compartment may include a label indicated the size of the cable ties it may be capable of holding. The indicia may also be color coding the compartment, wherein each color represents a range of sizes that the compartment may be capable of holding.

The compartments may be disposed relative to one another in a line, as shown in FIG. 1. In one embodiment, not shown in the figures, the compartments may be disposed so as to form other patterns, such as in a circle, a rectangle and so forth.

In one embodiment, the free standing, table top tie organizer 100 may also include means for connecting the cable tie organizer to a support, such as a wall, a door, a beam and so forth. Connecting means may include magnets for adhering to a metallic support, or one or more holes 111 on a side vertical wall of a compartment that would allow a nail or screw for connecting the cable tie organizer to the vertical support.

In one embodiment, one or more compartments may be provided with a lid 190 designed to cover the top end 112. The lid may be hinged to the compartment, or it may be a free lid.

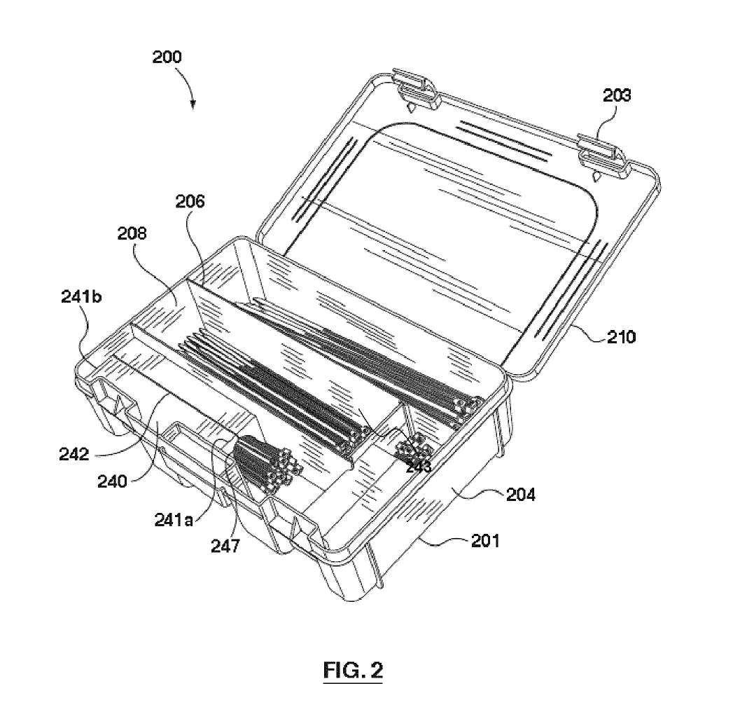

FIG. 2 illustrates another embodiment of a cable tie organizer 200 of the present invention. The cable tie organizer 200 may be a portable enclosure wherein compartments may be configured to accommodate the cable ties horizontally. The cable tie organizer 200 may include two or more compartments. The cable tie organizer 200 may take the form of a box and it may include a support base 201 having sidewalls 204. A number of vertical walls 206 may extend from the sidewalls 204. The vertical walls 206 may define the two or more, horizontal compartments 208. The compartments 208 may be of different lengths so as to accommodate cable ties of different lengths. The length of each compartment being about 1-2 inches (about 2.54 to 5.08 cm) longer than the length of the cable tie it receives. For example, the compartments may be of about 13 inches (about 33.02 cm) for holding 11 inches (about 27.94 cm) cable ties, about 9 inches (about 22.86 cm) for holding 7.5 inches (about 19.05 cm) cable ties, and of about 6 inches (about 15.24 cm) for holding 4 inches cable ties (about 10.16 cm). The cable tie organizer may be provided with a lid 210 hinged to the side walls 204. Locking tabs 203 may be provided to lock the lid 210. The lid may also be a free lid.

Each compartment may be designed or coded (e.g. color coded) or include an indicia for a cable tie of a specific length.

The compartments 208 may include insert means 240, which may be removable or fixed to the compartment. Insert means 240 may be made of a deformable material, such as foam, that is shaped to be frictionally received by a compartment. Insert means 240 may be an elongated member having two ends 241a,b, a surface 243 and a bore 247 that extends substantially longitudinally between the two ends 241a,b. The bore 247 may be an enlarged core suitable for keeping the cable ties within the insert 240. The insert 240 and may include a slit 242 on the surface 243 that extends substantially longitudinally from one end 241a to the other end 241b, and it extends from the surface 243 to the bore 247. Inserts 240 may be sized to have a length (i.e. from end 241a to end 241b) of about 1-2 inches smaller than the compartment in which it resides. This way, the head portion of the cable tie extends through the bore 247 thereby extending beyond one of the ends 241. The compartment 208 that includes an insert 240 may be filled with cable ties by pushing the cable ties through the slit 242 and accommodate the tape portion of the cable tie in the bore 247, while the head portion of the cable ties extends from the insert 240 end 241. The insert 240 or cable tie holder, may advantageously keep the cable ties within a compartment organized, may allow easier retrieval of one cable tie at a time and may allow for the cable ties to remain in the compartment in case the cable tie organizer is dropped or turned over. To retrieve a cable tie from an insert 240, one may simply grab the head portion of a cable tie and pull the cable tie from the insert. Because of the slit 242, only the cable tie being pulled will be retrieved.

The cable tie organizers 100, 200 of the present invention may be made of any suitable material, such as metal, plastic, wood or combinations thereof. The cable tie organizers 100, 200 may be made of a transparent material so as to facilitate viewing inside of the compartments, or from an opaque material. The cable tie organizers of the present invention may be manufactured by any means known in the art, for example by injection molding.

The present invention provides also for a kit, comprising a cable tie organizer of the present invention and one or more foamed cable tie holders. The kit, in another embodiment, may also include cable ties.

Without further elaboration, it is believed that one skilled in the art can, based on the description presented herein, utilize the present invention to the full extent. All publications cited are incorporated by reference. Any mechanism proposed below does not in any way restrict the scope of the claimed invention.

Although the description above contains many specificities, these should not be construed as limiting the scope of the invention but as merely providing illustrations of some of the presently preferred embodiments of this invention. For example, the compartments may have many shapes, such as circular, oval, trapezoidal, rectangular, triangular, etc. Thus the scope of the invention should be determined by the appended claims and their legal equivalents, rather than by the examples given.

1. A cable tie organizer having two or more compartments, each compartment configured to accommodate a different length of cable ties.

2. The cable tie organizer of claim 1, wherein the cable tie organizer is a table top cable tie organizer, and wherein the two or more compartments are configured to accommodate the cable ties in a substantially vertical disposition, each compartment including an open top end, a bottom closed end, and substantially vertical side walls extending between the top end and the bottom end, the bottom closed ends of the compartments being aligned so as to provide a generally flat support base, the cable tie organizer including at least two compartments having different heights.

3. The cable tie organizer of claim 2, wherein the cable tie organizer is a free standing cable tie organizer.

4. The cable tie organizer of claim 2, wherein the cable tie organizer further includes a cable tie holder within one or more compartments.

5. The cable tie organizer of claim 4, wherein the cable tie holder includes two ends and a bore extending between the two ends, the bore being sized for frictionally holding one or more elongated members therein.

6. The cable tie organizer of claim 5, wherein the cable tie holder includes a slit that extends substantially longitudinally between the two ends and the slit extends from a surface of the cable tie holder to the bore.

7. The cable tie organizer of claim 6, wherein each of the two or more compartments includes an indicium, each indicium being associated with the length of cable tie that the corresponding compartment accommodates.

8. The cable tie organizer of claim 6, wherein each one of the compartments includes a lid.

9. The cable tie organizer of claim 8, wherein the lid is hinged to the compartment.

10. The cable tie organizer of claim 1, wherein the cable tie organizer is a portable enclosure, and wherein the two or more compartments are configured to accommodate the cable ties horizontally.

11. The cable tie organizer of claim 10, wherein the cable tie organizer further includes a cable tie holder within the one or more compartments.

12. The cable tie organizer of claim 11, wherein the cable tie holder includes two ends and a bore extending between the two ends, the bore being sized for frictionally holding one or more elongated members therein.

13. The cable tie organizer of claim 12, wherein the cable tie holder includes a slit that extends substantially longitudinally between the two ends and the slit extends from a surface of the cable tie holder to the bore.

14. The cable tie organizer of claim 13, wherein each of the two or more compartments includes an indicium, each indicium being associated with the length of cable tie that the corresponding compartment accommodates.

15. A kit comprising the cable tie organizer of claim 5 and cable ties.

16-18. (canceled)

19. The kit of claim 15, wherein the cable tie holder includes a slit that extends substantially longitudinally between the two ends and the slit extends from a surface of the cable tie holder to the bore.

20. The kit of claim 19, wherein each of the two or more compartments includes an indicium, each indicium being associated with the length of cable tie that the corresponding compartment accommodates.

21. The kit of claim 20, wherein each one of the compartments includes a lid.

22. The kit of claim 21, wherein the lid is hinged to the compartment.
